(19) United States
(12) Patent Application Publication
(10) Pub. No.: US 2015/0090528 A1
(43) Pub. Date: Apr. 2, 2015

(54) Cabinet Mountable Sliding Step Stool

(71) Applicant: Debra Binegar, Washington C.H., OH (US)

(72) Inventor: Debra Binegar, Washington C.H., OH (US)

(21) Appl. No.: 14/505,487

(22) Filed: Oct. 2, 2014

Related U.S. Application Data
(60) Provisional application No. 61/885,936, filed on Oct. 2, 2013.

(51) Int. Cl. E06C 1/00; E06C 9/06; A47C 12/00

(52) U.S. Cl. CPC E06C 1/005; A47C 12/00; E06C 9/06
USPC 182/12

(57) ABSTRACT

A sliding step stool that can be mounted within a cabinet and extended for use. The step stool includes a first sidewall and a second sidewall that are parallel to one another and are connected by a flat panel. The flat panel provides an elevated surface on which a user can stand in order to access items stored in elevated areas, such as on or within high shelves or cabinets. The step stool includes a pair of sliding mechanisms on the sides or bottom thereof wherein the sliding mechanisms can be installed inside of a conventional cabinet. In a stored configuration, the step stool is enclosed within the cabinet, and in an extended configuration the step stool extends outward therefrom.

### CROSS REFERENCE TO RELATED APPLICATION

This application claims the benefit of U.S. Provisional Application No. 61/885,936 filed on Oct. 2, 2013. The above identified patent application is herein incorporated by reference in its entirety to provide continuity of disclosure.

### BACKGROUND OF THE INVENTION

1. Field of the Invention

The present invention relates to a sliding step stool that can be mounted within a cabinet. The sliding step stool includes a sliding mechanism that can be secured inside of a traditional cabinet. The sliding motion of the step stool allows the step stool to be stored discretely within a cabinet, or extended therefrom to provide a user with a step stool for reaching elevated areas.

Various items are often stored in elevated locations, such as in cabinets and on shelves. Many individuals may have difficulty reaching these elevated areas without the use of a stool or ladder. If the user tries to reach upward to pick up an item, the user may accidentally drop or knock over an item, causing it to break or creating a mess. Alternatively, the user may move a chair into the desired location, and stand on the chair in order to reach the elevated area. However, chairs are not constructed for users to stand on, and the chair may be unstable creating a risk of injury to the user.

In order to more easily reach an item in an elevated area, many people may retrieve a ladder or step stool from a storage area. However, these items are bulky and the user must retrieve and set up the step stool or ladder prior to use of the same. This is time consuming and inconvenient for the user. Thus, a step stool that is integrated into a cabinet or similar storage area that can pull out for use, and that can be positioned within the cabinet for storage is desired. In this way, a step stool is readily available for a user attempting to reach an elevated area.

The present invention provides a step stool that is mountable within a conventional cabinet, such as a kitchen cabinet. The step stool includes a pair of parallel sidewalls connected by a flat panel on the upper ends thereof. The flat panel provides an elevated surface on which a user may stand to reach items stored in a high cabinet or on a shelf. The surface of the panel may include a non-slip material thereon to prevent the user from slipping on the step stool. The sides or bottom of the step stool include sliding mechanisms thereon that can be mounted inside of a cabinet. The sliding mechanism allows the step stool to slide into and out of the cabinet. In a stored configuration, the step stool is enclosed within the cabinet. The step stool can be pulled outward from the cabinet in a horizontal plane into an extended configuration to allow the user to utilize the step stool of the present invention. The step stool may further include a pair of wheels thereon that are pivotally secured to the sidewalls thereof. The wheels are stored in a horizontal orientation and pivot and lock into a vertical orientation when the step stool is pulled out of the cabinet.

2. Description of the Prior Art

Devices have been disclosed in the prior art that relate to step stools. These include devices that have been patented and published in patent application publications. These devices generally relate to step stools mounted on kitchen cabinets or cabinet doors. The following is a list of devices deemed most relevant to the present disclosure, which are herein described for the purposes of highlighting and differentiating the unique aspects of the present invention, and further highlighting the drawbacks existing in the prior art.

One such device. U.S. Pat. No. 4,846,304 to Rasmussen discloses a collapsible step device for use with a kitchen cabinet shelf. The device includes a step unit and a mounting unit for securing the step unit to the underside of the shelf. The step unit can be positioned in an extended or retracted configuration relative to the shelf. Thus, Rasmussen discloses a step device storable within a kitchen cabinet, but does not disclose a step device having a sliding mechanism for moving the step unit into and out of the cabinet in a horizontal plane.

U.S. Pat. No. 5,085,290 to Guirlinger discloses a foldaway step device mountable to a cabinet door. The device includes a mounting plate securable to the cabinet door, a step surface, legs, and linkages. The step is stored in a vertical position against the door, and can be lowered into position by opening the door and pivoting the step to a horizontal position, wherein the legs contact the floor and support the step. Thus, Guirlinger discloses a cabinet mounted step stool, but fails to disclose a step stool slidably mounted within the cabinet so that it can be extend or retracted into the cabinet by moving the step stool in a horizontal plane.

U.S. Published Patent Application Number 2012/0086317 to Baran discloses a step stool that can be mounted in a cabinet. The step stool is mounted in a toe kick drawer on a cabinet. The step stool is pivotally connected to the toe kick drawer. Baran discloses a step stool mounted within a drawer, whereas the present invention differs from Baran in that it provides a step stool device having a sliding mechanism securable to a cabinet.

U.S. Pat. No. 5,358,067 to Ford et al. discloses a folding step assembly that is attached to a wall above the floor. The assembly includes a step member pivotally attached to a wall by a hinge, a brace attached to the step member by a hinge, and a stop for limiting the angle between the step member and brace. In a stored configuration, the brace is parallel to the step member and to the wall, and in an extended configuration the step member is parallel to the floor and the brace is disposed at an acute angle. Thus, while Ford et al. provides a step member, the step member is not slidably mounted within a cabinet.

U.S. Pat. No. 3,030,166 to Richards et al. discloses a combination cabinet and step ladder. The step ladder is mounted to the front of a cabinet door, and can be folded for storage. The interior of the cabinet is not occupied by the step ladder, allowing the cabinet to be used for storage. The step ladder can be extended from the front of the cabinet for use. Thus, Richards et al. fails to disclose a sliding step stool mounted within a cabinet.

Finally, U.S. Pat. No. 3,481,429 to Gaede discloses a drawer step for use with a kitchen cabinet. The device includes a frame that can be mounted into a conventional kitchen cabinet. The device further includes a step, a support structure, and legs that are slidably stored within the frame. Thus, while Gaede discloses a step stool, the stool does not merely slide into and out of a cabinet, and includes pivoting elements and legs.

These prior art devices have several known drawbacks. Devices in the prior art generally relate to step stools and step ladders mounted on or in a kitchen cabinet. However, such devices include various structures that fold or pivot into position and must be configured by the user in order to provide step stool. In contrast, the present invention provides a sliding mechanism that allows a step stool to slide into and out of a kitchen cabinet in a horizontal plane. Thus, the user must simply slide the step stool forward and out of the cabinet for use, and can slide the step stool back into the cabinet for storage.

In light of the devices disclosed in the prior art, it is submitted that the present invention substantially diverges in design elements from the prior art and consequently it is clear that there is a need in the art for an improvement to existing step stool devices. In this regard the instant invention substantially fulfills these needs.

### SUMMARY OF THE INVENTION

In view of the foregoing disadvantages inherent in the known types of step stools now present in the prior art, the present invention provides a new step stools wherein the same can be utilized for providing convenience for the user when storing a step stool in an easily accessible and convenient manner.

It is therefore an object of the present invention to provide a new and improved step stool device that has all of the advantages of the prior art and none of the disadvantages.

It is another object of the present invention to provide a step stool that is slidably positioned within a conventional cabinet.

Another object of the present invention is to provide a step stool that can be stored discretely within a conventional cabinet.

Yet another object of the present invention is to provide a step stool having a high friction surface for help prevent the user from slipping or falling.

Another object of the present invention is to provide a step stool that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the sliding step stool of the present invention in an extended configuration.

FIG. 1B shows a perspective view of the sliding step stool of the present invention in a retracted configuration.

FIG. 2 shows a bottom view of the sliding step stool of the present invention.

FIG. 3 shows a view of an alternate embodiment of the sliding step stool of the present invention.

### DETAILED DESCRIPTION OF THE INVENTION

Reference is made herein to the attached drawings. Like reference numerals are used throughout the drawings to depict like or similar elements of the cabinet mounted sliding step stool of the present invention. For the purposes of presenting a brief and clear description of the present invention, the preferred embodiment will be discussed as used for providing a user with a step stool that can be conveniently stored within a kitchen cabinet and that is extendable therefrom. The figures are intended for representative purposes only and should not be considered to be limiting in any respect.

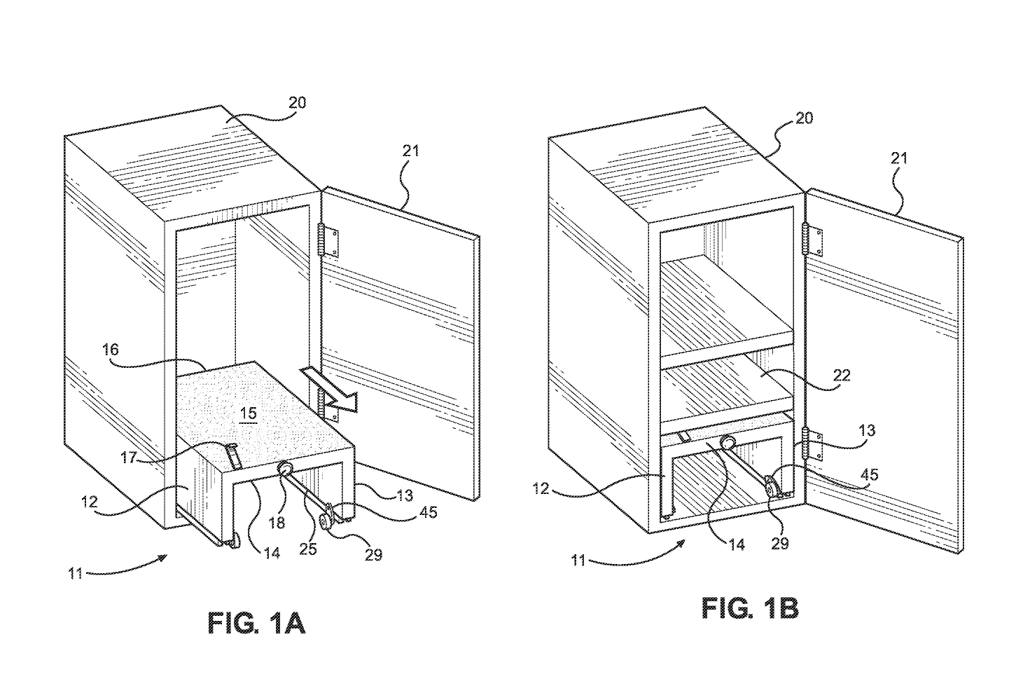

Referring now to FIGS. 1A and 1B, there is shown a perspective view of the sliding step stool of the present invention in an extended and retracted configuration, respectively. The present invention provides a step stool 11 that can be slidably mounted within a cabinet. The step stool 11 of the illustrated embodiment comprises a first sidewall 12 and a second sidewall 13 that are substantially parallel to one another. A flat panel is disposed in a horizontal orientation on the upper end of the first and second sidewall 12, 13 such that the flat panel connects the first and second sidewalls 12, 13. The flat panel is disposed in a horizontal orientation so that a user may stand thereon. The first and second sidewalls 12, 13 extend along opposing sides of the flat panel from the front end 14 thereof to the rear end 16 thereof. Thus, the step stool 11 is substantially rectangular in configuration and comprises a U-shaped cross section.

The step stool 11 is sized so as to be stored within a conventional kitchen cabinet 20. The step stool 11 can be positioned within the lower end of a kitchen cabinet 20 so that it is adjacent to, or in contact with, the floor of the kitchen. In a retracted configuration, the front end 14 of the step stool 11 is flush with or inside of the front of the cabinet 20. In embodiments wherein the step stool 11 comprises a handle 18 on a front end thereof, the handle 18 is positioned within the front end of the cabinet 20 so that the cabinet door 21 can be closed. This allows the step stool 11 to be fully and discretely stored within a cabinet 20.

In an extended configuration, the step stool 11 can be extended from the cabinet 20 so as to protrude outward therefrom. The user may hold the handle 18 on the front end 14 of the step stool 11 and can pull the step stool 11 outward from the cabinet 20 in a horizontal plane. Thus, the step stool 11 slides outward from the cabinet 20 in a substantially horizontal motion. The upper surface 15 of the step stool 11 is exposed so that a user can stand thereon. The upper surface 15 of the flat panel preferably comprises a high friction or non-slip material or coating thereon so as to prevent a user from slipping or falling while standing on the upper surface 15.

The front end of the step stool may include a pair of wheels 29 thereon. Preferably, the wheels 29 are able to retract or pivot into a stored position so that the step stool 11 and wheels 29 can be retracted into the cabinet 20 for storage. In the illustrated embodiment, the wheels 29 are secured to the step stool 11 via pivoting brackets 45. The pivoting brackets 45 allow the wheels 29 to be positioned along the interior surface of the sidewalls 12, 13 while the step stool 11 is in a retracted position within a cabinet 20. When the step stool 11 is extended outward from the cabinet 20 for use, the brackets 45 pivot downwards so that the wheels 29 contact the ground. The brackets 45 are adapted to lock in a vertical orientation when the wheels 29 contact the ground so that the wheels 29 can be used to support and stabilize the step stool 11. The wheels 29 engage the ground and allow the step stool 11 to be easily rolled into and out of the cabinet 20. Further, the wheels 29 are adapted to lock when the step stool 11 is in an extended configuration so as to prevent the step stool 11 from moving or rolling while the user is standing thereon.

The step stool 11 may further comprise a safety lock 17 thereon. The safety lock 17 prevents a child from moving the step stool 11 into an extended configuration, wherein the child may be able to gain access to a kitchen counter or cabinets. In the illustrated embodiment, the safety lock 17 comprises a rectangular bar on a front end 14 of the upper surface 15 of the step stool 11. The safety lock 17 is preferably spring-biased in an angled orientation such that the rectangular bar extends upward from the surface of the step stool. In this way, when the step stool 11 is in a stored configuration, the safety lock 17 can engage a portion of the cabinet 20 or a shelf 22 therein so as to prevent the step stool 11 from sliding outward from the cabinet 20 into an extended configuration. This prevents children from gaining access to the step stool 11. A user can easily disengage the safety lock 17 by depressing a portion of the safety lock 17 so that the safety lock 17 no longer engages the cabinet 20 or a shelf 22 therein.

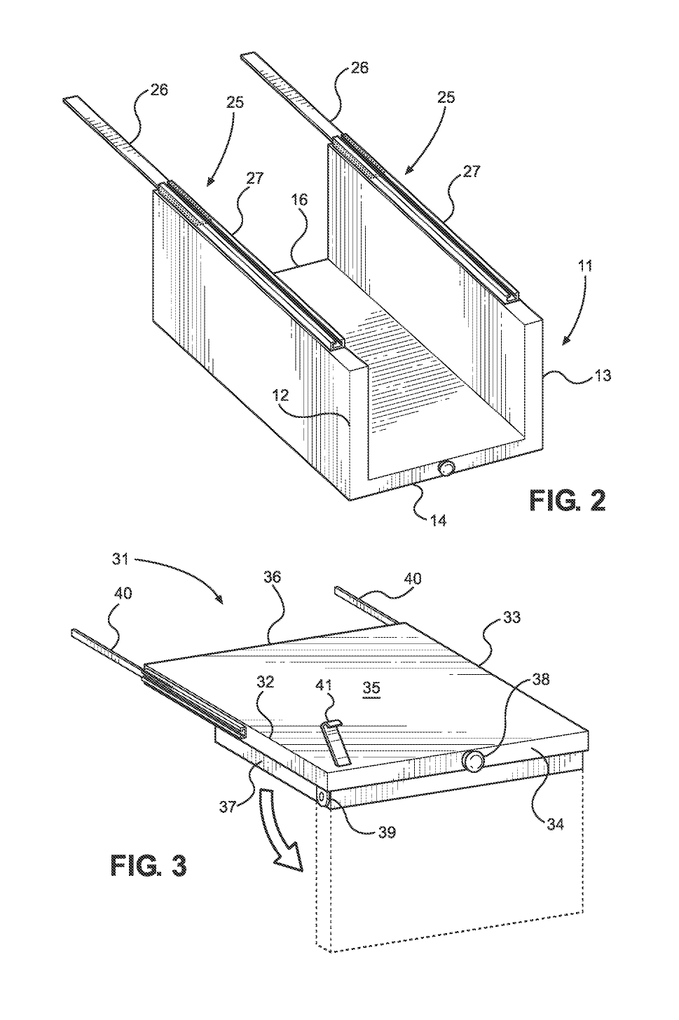

Referring now to FIG. 2, there is shown a view of the underside of the step stool of the present invention. The step stool 11 of the present invention further comprises a pair of sliding mechanisms 25 that allow the step stool 11 to be slidably mounted within a cabinet. The sliding mechanisms 25 allow the step stool 11 to be retracted into and extended from a cabinet. Further, the sliding mechanism 25 may be telescopic and include a plurality of sliding sections. A first section 26 of each sliding mechanism 25 can be mounted inside of a kitchen cabinet using any suitable fasteners, such as screws, nails, bolts, or adhesives, among others. A second section 27 of each sliding mechanism 25 is secured to the step stool 11 using fasteners, such as adhesives, screws, bolts, or nails, among others. The first and second sections 26, 27 of the sliding mechanism 25 can slide relative to one another, allowing the step stool 11 to extend outward from the kitchen cabinet.

In the illustrated embodiment, the sliding mechanisms 25 are mounted on the bottom end of the first and second sidewall 12, 13 of the step stool 11, respectively. However, in alternative embodiments, the sliding mechanisms 25 can be mounted on opposing sides of the step stool 11 rather than on the bottom end thereof. The sliding mechanisms are substantially horizontal and are parallel to one another. Further, the sliding mechanisms 25 extend from the front end 14 of the step stool 11 to the back end 16 thereof. The sliding mechanisms 25 may be adapted to lock the step stool 11 in an extended position so as to prevent the step stool 11 from sliding into or out of the cabinet while the user is standing thereon.

Referring now to FIG. 3, there is shown a view of an alternate embodiment of the step stool of the present invention. The illustrated embodiment shows a step stool 31 that includes a flat plate having an upper surface 35 on which a user can stand. The upper surface 35 may include a non-slip or high friction coating thereon to help prevent the user from falling while standing on the step stool 31. The flat plate is disposed in a horizontal orientation and includes a first side 32, a second side 33, a front end 34, and a back end 36. The front end 34 of the flat plate may include a handle 38 thereon for helping the user to slide the step stool 31 into and out of a cabinet in which it is installed.

The front end 34 of the flat plate further includes a support 37 pivotally secured thereto via a hinge 39. The support 37 is disposed on the lower surface of the flat plate. The support 37 may comprise a flat, rectangular panel. In a folded configuration, the support 37 is flush against and is parallel to the flat plate. In an unfolded configuration, the support 37 is perpendicular to the flat plate and contacts the floor or ground so as to support the flat plate in an elevated position.

The first and second sides 32, 33 of the flat plate each include a sliding mechanism 40 thereon. The sliding mechanisms 40 are elongated members that extend from the front end 34 of the flat plate to the back end 36 thereof. A first section of the sliding mechanism 40 is secured to the flat plate using any suitable fasteners, and a second section can be secured to the interior of a cabinet using any suitable fasteners. The first and second sections may slide relative to one another. Further, the sliding mechanisms 40 may be telescopic such that the step stool 31 can slide into and out of the cabinet. Thus, the sliding mechanisms 40 allow the flat plate to slide into and out of the cabinet in a horizontal plane. The sliding mechanisms 40 are also adapted to lock the step stool 31 in an extended position so as to prevent the step stool 31 from sliding into or out of the cabinet while the user is standing thereon.

The upper surface 35 of the flat plate may include a safety lock 41 thereon. The safety lock 41 operates similarly to the safety lock shown in FIGS. 1A and 1B. The safety lock 41 is preferably spring-biased in an angled orientation such that the rectangular bar extends upward from the surface 35 of the step stool 31. The safety lock 41 is adapted to engage a portion of a cabinet or a shelf therein. This helps to prevent children from gaining access to the step stool 31.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A step stool slidably mountable in a cabinet, comprising:
a first sidewall substantially parallel to a second sidewall;
wherein said first sidewall and said second sidewall are connected by a flat panel disposed on an upper end of said first sidewall and of said second sidewall;
a first sliding mechanism disposed on said first sidewall and a second sliding mechanism disposed on said second sidewall, wherein said first and second sliding mechanisms are adapted to be mounted in a cabinet and allow said flat panel to be extended from said cabinet in a horizontal motion.

2. The step stool of claim 1, wherein said first sidewall and said second sidewall are substantially parallel to one another.

3. The step stool of claim 1, wherein said flat panel comprises an upper surface having a high friction material thereon.

4. The step stool of claim 1, wherein said first sliding mechanism is disposed on said first sidewall, and wherein said second sliding mechanism is disposed on said second sidewall.

5. The step stool of claim 4, wherein said first sliding mechanism is disposed on a bottom end of said first sidewall, and wherein said second sliding mechanism is disposed on a bottom end of said second sidewall.

6. The step stool of claim 1, wherein each of said first and second sliding mechanisms are telescopic.

7. The step stool of claim 1, wherein each of said first and second sliding mechanisms include a first section slidably connected to a second section, wherein said first section is adapted to be secured to a cabinet, and wherein said second section is secured to said flat plate.

8. The step stool of claim 1, wherein said front end comprises a pair of wheels thereon that are adapted to engage a horizontal surface adjacent a cabinet.

9. The step stool of claim 1, wherein said pair of wheels is connected to pivoting brackets that allow said pair of wheels to be folded for storage.

10. The step stool of claim 1, further comprising a safety lock thereon for preventing said flat panel from being extended from said cabinet.

11. A step stool slidably mountable in a cabinet, comprising:
a flat plate having a front end, a back end, a first side, and a second side;
a support pivotally secured to said flat plate by means of a hinge and movable between a folded position wherein said support is parallel to said flat plate, and an unfolded position wherein said support is perpendicular to said flat plate;
a first sliding mechanism disposed on said first side of said flat plate, and a second sliding mechanism disposed on said second side of said flat plate, wherein said first and second sliding mechanisms are mountable within a cabinet.

12. The step stool of claim 11, wherein said first and second sliding mechanisms each comprise a first section slidably connected to a second section;
said first section mountable to a kitchen cabinet, and said second section secured to said flat plate.

13. The step stool of claim 11, further comprising a safety lock thereon adapted to prevent said flat plate from sliding outward from said cabinet.
